(19) United States
(12) Patent Application Publication
(10) Pub. No.: US 2010/0104939 A1
(43) Pub. Date: Apr. 29, 2010

(54) BATTERY PACK

(75) Inventors: Chuanfu Wang, Guangdong (CN); Shen Xi, Guangdong (CN); Jianhua Zhu, Guangdong (CN); Weixin Zheng, Guangdong (CN)

Correspondence Address: BRINKS HOFER GILSON & LIONE, P.O. BOX 10395, CHICAGO, IL, 60610, US

(73) Assignee: BYD Company Limited, Shenzhen, Guangdong (CN)

(21) Appl. No.: 12/523,097

(22) PCT Filed: Dec. 27, 2007
(86) PCT No.: PCT/CN2007/071348

§ 371 Date: Jul. 14, 2009

(30) Foreign Application Priority Data
May 29, 2007 (CN) 200710103771.3

(51) Int. Cl. H01M 2/26; H01M 6/02

(52) U.S. Cl. 429/160; 29/623.1; 29/623.2

(57) ABSTRACT

The present invention discloses a battery pack, which comprises a plurality of unit cells (1) each of which has two electrode terminals (2 and 3), and which are connected in series or in parallel by connecting an electrode terminal (2 or 3) of a unit cell (1) to an electrode terminal (3 or 2) of an adjacent unit cell (1), characterized in that, the electrode terminals (2 and 3) each is formed in a sheet shape, and the connection between the electrode terminals (2 and 3) is the binding of two sheets. According to the present invention, the battery pack has a low internal resistance, light weight, and reliable connection.

### TECHNICAL FIELD

This invention relates to a battery pack.

### BACKGROUND

With the popularization of environmental consciousness, the electric vehicle or hybrid vehicle shall substitute the existing fuel-combustion vehicle in future. As the core power source of electric vehicle, the power battery pack is especially important, which may be formed by a plurality of cells connected in series or in parallel.

CN 1767245A discloses a battery module. As shown in FIG. 1, the module comprises a plurality of unit cells 1 arranged in a housing, a connecting member 20 and a fixing member 21. Each unit cell 1 includes a positive terminal 2 and a negative terminal 3 protruded out. The connecting member 20 couples the positive terminal 2 and the negative terminal 3 of one unit cell 1 to the negative terminal 3 and the positive terminal 2 of the adjacent unit cell 1 respectively, that is, the battery module is formed by connecting the unit cells in series. Male threads are formed on the positive terminal 2 and the negative terminal 3, and female threads are formed in the fixing member 21, so that the connecting member 40 is fixed to the positive terminal 2 and the negative terminal 3 by tightening the fixing member 21.

In the battery module as mentioned above, the positive terminal and the negative terminal are connected threadly and fixed by the fixing member, thus its contact resistance is high; if the thread connection looses, the contact resistance will be higher. Thus, the internal resistance of this battery module is very high; moreover, because each unit cell requires the positive and negative terminals with male threads as the conducting element, and the connecting member and the fixing member for connecting multiple unit cells in series, thus, the weight and volume of the battery module are increased.

### SUMMARY OF THE INVENTION

This invention aims to provide a battery pack which has a low internal resistance.

This invention provides a battery pack, which comprises a plurality of unit cells each of which has two electrode terminals, and which are connected in series or in parallel by connecting an electrode terminal of a unit cell to an electrode terminal of an adjacent unit cell, wherein the electrode terminals each is formed in a sheet shape, and the connection between the electrode terminals is the binding of two sheets.

For the battery pack in this invention, the electrode terminals of the unit cell, i.e., the positive terminal and the negative terminal are formed in a sheet shape, so that multiple unit cells can be connected electrically together through binding the sheet shape electrode terminals of adjacent two unit cells, with almost no contact resistance between unit cells, and the electrode terminals bound together will not loose. Thus, as compared with the prior battery pack in which the unit cells are screwed together, the battery pack in the present invention has low internal resistance, light weight, and reliable connection.

Moreover, the battery pack adopts the sheet as the electrode terminal which can be directly bound together, so it is not necessary to use additional connecting members and, as a result, the weight and volume of the battery pack may be greatly reduced.

### BRIEF DESCRIPTION OF THE DRAWINGS

FIG. 1 is a schematic view of a conventional battery pack;

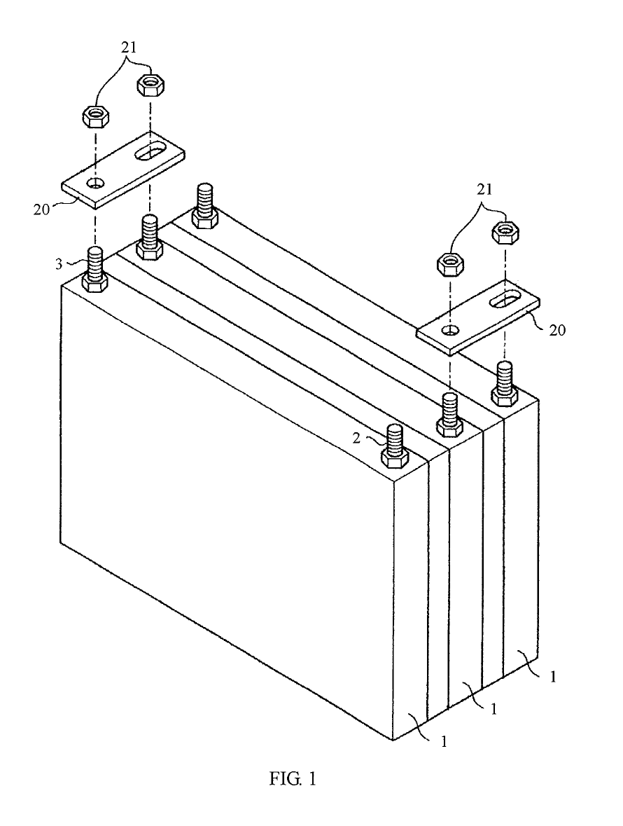

FIG. 2 is a schematic view of the present battery pack;

FIG. 3 is a side sectional view of the present battery pack;

FIG. 4 is a sectional view of a unit cell in the present battery pack;

FIG. 5 and FIG. 6 are the schematic views of sealing member that seals the cover plate and the electrode terminal of the unit cell in the present battery pack.

### DETAILED DESCRIPTION OF CERTAIN INVENTIVE EMBODIMENTS

Hereinafter, the present invention will be described in detail with reference to the drawings.

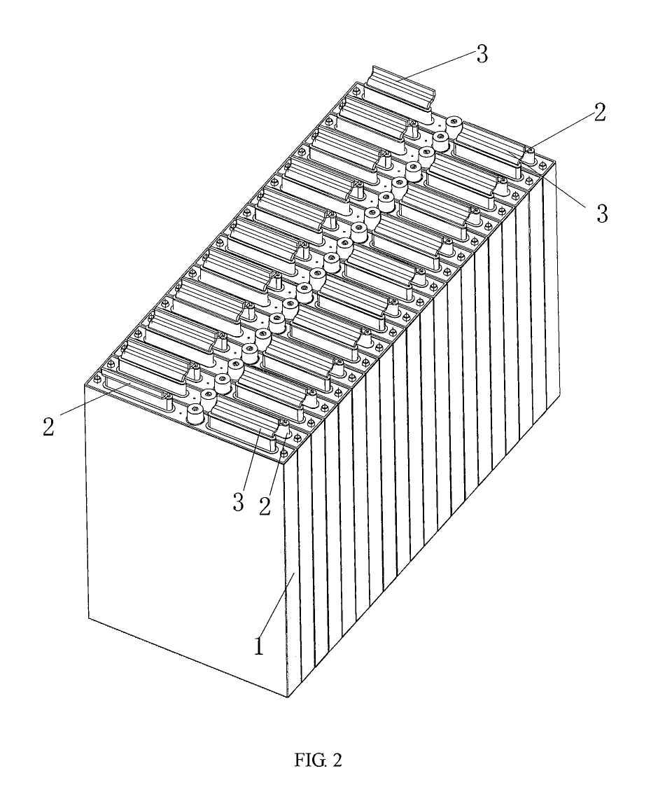

As shown in FIGS. 2, 3 and 4, the present invention provides a battery pack, which comprises a plurality of unit cells 1 each of which has two electrode terminals 2 and 3, and which are connected in series or in parallel by connecting an electrode terminal 2 or 3 of a unit cell 1 to an electrode terminal 3 or 2 of an adjacent unit cell 1, characterized in that, the electrode terminals 2 and 3 each is formed in a sheet shape, and the connection between the electrode terminals 2 and 3 is the binding of two sheets.

In the present invention, the unit cell may be any suitable type in the prior art, such as the prismatic cell or cylindrical cell. Multiple unit cells may be connected in series or in parallel to form the battery pack.

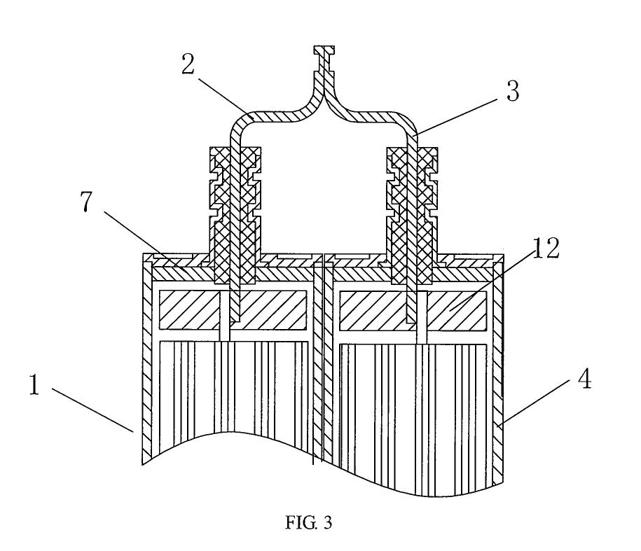

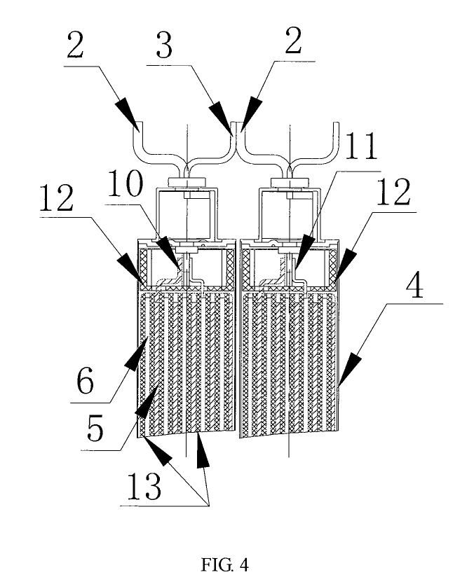

As shown in FIG. 3 and FIG. 4, each unit cell usually comprises a case 4 and electrode assembly housed in the case 4. The electrode assembly usually comprises a positive plate 5, a negative plate 6 and a separator 13 that is interposed therebetween. The case 4 usually at one end includes a cover plate 7 having a through hole formed therethrough, and the electrode terminals (including the positive terminal 2 and the negative terminal 3) may be protruded out through the through hole so as to output the current of the cell. Moreover, the gap between the electrode terminal and the through hole is usually sealed by a sealing member to avoid the leakage of electrolyte from the case 4 of the cell.

Within the unit cell, the positive and negative terminals may be directly connected with the positive and negative plates, for example, the positive terminal may be welded with the positive plate, and the negative terminal may be welded with the negative plate. Preferably, the positive plate 5 has a positive tab 10 which is connected with the positive terminal 2; the negative plate 6 has a negative tab 11 which is connected with the negative terminal 3.

The positive and negative tabs may be made of various conductive materials, which may be preferably one or more of copper, nickel and aluminum. Preferably, the electrode terminal is connected with the electrode tab and the electrode tab is connected with the electrode plate by means of welding, such as ultrasonic welding, cold pressure welding, laser welding, brazing, flash butt welding, friction welding, and electric resistance welding.

The welding position between the negative tab 11 and the negative terminal 3, as well as between the positive tab 10 and the positive terminal 2 may be provided with an insulating ring 12 respectively. The insulating ring 12 is formed as two segments, during assembly, the insulating ring may be enclosed around the welding position for insulating and shock absorbing to improve the safety of the cell. The insulating ring may be made of various insulation materials such as plastics and rubbers.

After multiple unit cells are connected together to form the battery pack, the battery pack may be fixed by means of various methods in the prior art, such as arrangement of heat-sinking structure between adjacent unit cells, and fasten the connected unit cells together to avoid the displacement of the unit cells.

In the present invention, in order to install the sheet shape electrode terminal and assemble the battery pack easily, the unit cell is preferably the prismatic cell. The width of the sheet shape electrode terminal may be 5-40% of the width of the unit cell, 10-25% is preferred; the thickness of the sheet shape electrode terminal may be 1-20% of the unit cell thickness, 3-15% is preferred.

As shown in FIG. 2, the unit cell 1 is connected in series to form the battery pack, that is, an electrode terminal of a unit cell is connected with an electrode terminal having reverse polarity of an adjacent unit cell. In order to output the current of the battery pack, in the two unit cells at both ends of the battery pack, one electrode terminal of one unit cell and one electrode terminal having reverse polarity of another unit cell may be used for connecting the external electrical equipment. In particularly, the negative terminal 3 of the unit cell at one end of the battery pack is connected with the positive terminal 2 of its adjacent unit cell, and the positive terminal 2 thereof is used for connecting with external electrical equipment. The positive terminal 2 of the unit cell at another end of the battery pack is connected with the negative terminal 3 of its adjacent unit cell, the negative terminal 3 thereof is used for connecting with external electrical equipment. Among other adjacent two unit cells, the positive terminal 2 is connected with the negative terminal 3, so as to form a battery pack in series. Multiple unit cells may be also formed a battery pack in parallel as in the prior art, and its detailed description is omitted here.

In the present invention, the electrode terminal is formed in a sheet shape, and the electrode terminals are connected through the binding of the sheets. The binding of the sheets may be further fixed by means of various manners, such as welding, gluing or a clamp, or any combinations thereof, for example, a clamp may further used after the welding or gluing. In a preferred embodiment as shown in FIG. 2, the ends of two sheet shape electrode terminals connected with each other may be bent towards each other and bound together, which can simplify the fix and connection of two electrode terminals.

In the present invention, two sheet shape electrode terminals are preferably fixed by welding, such as the cold pressure welding, ultrasonic welding, laser welding, brazing, flash butt welding, friction welding, and electric resistance welding, wherein the cold pressure welding is preferred. For cold pressure welding, only the adequate static pressure may realize the reliable weld, and during the weld process, the heat emission is low, no vibration and no relative displacement will be occurred.

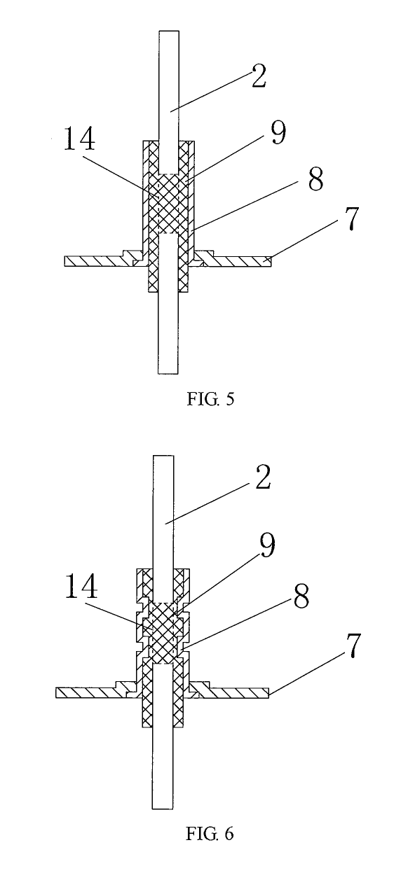

In an embodiment as shown in FIG. 5 and FIG. 6, the sealing member between the cover plate and the electrode terminal may comprises an insulating elastic component 9 held at the outside of the sheet shape electrode terminal, and a rivet 8 clamped on the insulating elastic component 9. The insulating elastic component 9 may be an elastic insulating material such as plastics and rubber. FIG. 5 illustrates the status of the rivet before clamped, and FIG. 6 illustrates the status of the rivet after clamped. As shown in FIG. 6, after the rivet 8 is clamped, the insulating elastic component 9 has elastic deformation, so as to tightly contact with the electrode terminal and the inner wall of the rivet, so that the electrode terminal is sealed. With this sealing member, the cover plate and electrode terminal may be tightly sealed to effectively prevent the intrusion of impurities such as moisture etc.

The rivet 8, the insulating elastic component 9 and the electrode terminal may be integrated by injection molding. That is, the rivet 8, the insulating elastic component 9 and the electrode terminal may be integrated together through injection molding, and then match the integral structure with the through hole on the cover plate. And then, as shown in FIG. 6, the rivet is tightly clamped to seal the electrode terminal. In this preferred embodiment, the sealing can be realized easily and reliably.

In addition, in a preferred embodiment as indicated by the broken line in FIG. 5 and FIG. 6, on the sheet shape electrode terminal, the places clamped by the insulating elastic component 9 may form one or more through holes 14. Thus, during the injection molding, the insulating elastic component 9 may be integrated more closely and tightly with the sheet shape electrode terminal through the through hole 14, thus reinforces its strength and ensures its structural stability.

As it may be seen from the above description, in the battery pack according to the present invention, the electrode terminal of the unit cell, i.e., the positive terminal and the negative terminal are formed in a sheet shape, through binding of the sheet shape electrode terminals of adjacent two unit cells, the electrical connection of multiple unit cells can be realized, and almost no contact resistance will be occurred between the unit cells, moreover, after welding, no loose problems of electrode terminals will be occur. Thus, as compared with the prior battery pack with screwed unit cells, the battery pack in the present invention has lower internal resistance.

Moreover, the present battery pack adopts the sheet shape electrode terminal which can be directly welded, no additional connecting member is necessary, thus, the weight and volume of the battery pack may be greatly reduced.

1-8. (canceled)

9. A battery pack, comprising:
a plurality of unit cells, each having two electrode terminals, the electrode terminal formed in a sheet-like shape having a cross-sectional area;
wherein a unit cell is connected to an adjacent unit cell in series by connecting an electrode terminal of the unit cell to an electrode terminal of the adjacent unit cell;
and wherein the connection between the electrode terminal of the unit cell and the electrode terminal of the adjacent unit cell binds the electrode terminals along a corresponding cross-sectional area of contact.

10. The battery pack of claim 9, wherein an end of the sheet-like shaped electrode terminal of the unit cell is bent toward and contacts an end of the sheet-like shaped electrode terminal of the adjacent unit cell, and the respective ends are fixedly bound together to form the connection between the unit cell and the adjacent unit cell.

11. The battery pack of claim 10, wherein the ends of the sheet-like shaped electrode terminals are fixedly bound together to establish a physical and electrical connection.

12. The battery pack of claim 10, wherein the ends of the sheet-like shaped electrode terminals are fixedly bound together by welding, clamping and/or conductive gluing.

13. The battery pack of claim 9, wherein the unit cell has a prismatic, circular, or rectangular cross-sectional shape.

14. The battery pack of claim 9, wherein the sheet-like shaped electrode terminal has a width of between 5% and 40% of a width of the unit cell, and has a thickness of between 1% and 20% of a thickness of the unit cell.

15. The battery pack of claim 9, further including for each unit cell:
a cover plate having a through-hole configured to receive a portion of the sheet-like shaped electrode terminal therethrough; and
a sealing member configured to seal a gap formed between the sheet-like shaped electrode terminal and an inside perimeter of the through-hole.

16. The battery pack of claim 15, wherein the sealing member comprises an insulating elastic component circumscribing a portion of the sheet-like shaped electrode terminal and a crimping member that compresses the elastic component about the sheet-like shaped electrode terminal.

17. The battery pack of claim 16, wherein the crimping member, the insulating elastic component and the sheet-like shaped electrode terminal are integrated using injection molding.

18. The battery pack of claim 16, wherein the sheet-like shaped electrode terminal has a through hole through a cross-section thereof configured to receive a portion of the compressed elastic component.

19. A method of forming a battery pack, comprising:
providing a plurality of unit cells, each having two electrode terminals;
forming the electrode terminals in a sheet-like shape having a cross-sectional area;
connecting in series an electrode terminal of the unit cell with an electrode terminal of an adjacent unit cell; and
binding the electrode terminals along a corresponding cross-sectional area of contact to form a connection between the unit cell and the adjacent unit cell.

20. The method claim 19, including:
bending an end of the sheet-like shaped electrode terminal of the unit cell toward an end of the sheet-like shaped electrode terminal of the adjacent unit cell, the respective ends contacting each other; and
fixedly binding the ends together to form the connection between the unit cell and the adjacent unit cell.

21. The method of claim 20, wherein fixedly binding the ends of the sheet-like shaped electrode terminals together establish a physical and electrical connection.

22. The method of claim 20, including fixedly binding the ends of the sheet-like shaped electrode terminals together by welding, clamping and/or conductive gluing.

23. The method of claim 19, further providing the sheet-like shaped electrode terminal having a width of between 5% and 40% of a width of the unit cell, and having a thickness of between 1% and 20% of a thickness of the unit cell.

24. The method of claim 19, further including:
providing a cover plate for each unit cell;
forming a through-hole in the cover plate, the through-hole configured to receive a portion of the sheet-like shaped electrode terminal therethrough; and
providing a sealing member configured to seal a gap formed between the sheet-like shaped electrode terminal and an inside perimeter of the through-hole.

25. The method of claim 24, further including:
providing an insulating elastic component configured to circumscribe a portion of the sheet-like shaped electrode terminal; and
compressing the elastic component about the sheet-like shaped electrode terminal to form a seal.

26. The method of claim 25, further including forming a through-hole through a cross-section of the sheet-like shaped electrode terminal and compressing the elastic component so that the through-hole receives a portion of the compressed elastic component.

27. A battery pack, comprising:
a plurality of unit cells, each having two electrode terminals, the electrode terminal formed in a sheet-like shape having a cross-sectional area;
wherein a unit cell is connected to an adjacent unit cell in parallel by connecting an electrode terminal of the unit cell to an electrode terminal of the adjacent unit cell;
and wherein the connection between the electrode terminal of the unit cell and the electrode terminal of the adjacent unit cell binds the electrode terminals along a corresponding cross-sectional area of contact.
